(19) United States
(12) Patent Application Publication
(10) Pub. No.: US 2011/0273504 A1
(43) Pub. Date: Nov. 10, 2011

(54) SWATH PRINTER AND METHOD FOR APPLYING AN INK IMAGE TO A RECEIVING MEDIUM USING A SWATH PRINTER

(75) Inventors: Hubertus M.J.M. BOESTEN, Melick (NL); Richard J.M. VAN DE VEN, Moergestel (NL); Jacobus H. SANDEE, Eindhoven (NL)

(73) Assignee: OCE-TECHNOLOGIES B.V., Venlo (NL)

(21) Appl. No.: 13/105,624

(22) Filed: May 11, 2011

Related U.S. Application Data
(63) Continuation of application No. PCT/EP2009/064579, filed on Nov. 4, 2009.

(30) Foreign Application Priority Data
Nov. 11, 2008 (EP) 08168823.6

(51) Int. Cl. B41J 29/38

(52) U.S. Cl. 347/14

(57) ABSTRACT

A swath printer includes a print head that is moveable along a scan direction for applying an ink image to a receiving medium. A transport mechanism is configured to move the receiving medium and the print head with respect to each other in a transport direction that is substantially orthogonal to the scan direction. A first sensor is arranged to detect a position of a first reference pattern present on the receiving medium in a first area thereof, and a second sensor is arranged to detect a position of a second reference pattern present on the receiving medium in a second area thereof. A controller is provided to control the printer on the basis of the detected positions of the reference patterns during use of the printer.

### CROSS-REFERENCE TO RELATED APPLICATIONS

This application is a Continuation of copending PCT International Application No. PCT/EP2009/064579 filed on Nov. 4, 2009, which designated the United States, and on which priority is claimed under 35 U.S.C. §120. This application also claims priority under 35 U.S.C. §119(a) on Application No. 08168823.6, filed in Europe on Nov. 11, 2008, 2008. The entire contents of each of the above documents is hereby incorporated by reference into the present application.

### BACKGROUND OF THE INVENTION

1. Field of the Invention

The present invention relates to the field of printers. In particular the present invention relates to the field of swath printers, such as inkjet printers. Furthermore, the present invention relates to a method of applying an ink image to a receiving medium using a swath printer.

2. Description of Background Art

Swath-type printers and methods applying an ink image to a receiving medium using a swath printer are known in the background art. Such printers may comprise a carriage for holding a print head, which carriage is moveable along a carriage scan-axis for applying an ink image to a strip of receiving material. The receiving material, such as a paper sheet, can be stepwise advanced in the direction of advance, which extends in a direction substantially orthogonal to the carriage scan-axis. During the printing of an image, the carriage is driven back and forth along the scan-axis to print the successive swaths with the print head. Transporting means are provided for stepwise advancing of the receiving material between each successive swath.

A known problem with swath-type printers is the accurate positioning of the stepwise advancing of the receiving material effected by the transporting means. The need for precise positioning of the receiving material is increased when the printer is a high-resolution printer used for printing graphics with high resolution.

U.S. Pat. No. 4,916,638 describes a media advance-system for swath-type printers for precise positioning of the receiving material for successive swath-printing. The media advance-system is provided with a dual photodiode sensor, which is mounted on the print head. This print head is provided with nozzles, which nozzles are positioned along a line that extends in the direction of advance of the receiving material. The print head is used to print lines in the margin of the receiving material using the first and Nth nozzle of the print head. These lines in the margin can be detected with the dual photodiode sensor. In order to obtain a defined stepwise advancing of the receiving material, the following method is used: First, the sensor is positioned over a line in the margin printed by the first nozzle, and the resulting difference signal of the two photodiodes of the sensor is saved as a reference value. Subsequently, the receiving material is advanced until the same value of the difference signal is obtained from the line image of the marginal line drawn by the Nth nozzle. Finally, the receiving material is advanced over a predetermined amount to position the receiving material for the next successive swath to be printed.

A concern of the method of U.S. Pat. No. 4,916,638 is that after each advancing step of the receiving material, a calibration step is required for positioning the receiving material before the next successive swath can be printed. A further concern is that advancement of the receiving material is relatively slow in order to obtain the same value of the difference signal and not to overshoot this position. Still a further concern is that it is not possible to detect whether or not the receiving material is skewed with respect to the print head.

A different solution for the identified problem of swath-type printers is proposed in JP 11301883, in which a printer is described that is provided with a sensor system arranged to detect the skew of a recording medium caused by a paper feed miss during advance by detecting the skew of the recording medium when it is fed via the presence or absence of a time difference when two sensors arranged on a paper feeder at a fixed interval detect the feeding of the recording medium. The printer of JP 11301883 comprises two paper tip sensors that are able to detect the presence of the leading edge of the recording medium. The difference of the arrival time of the right and left ends of the recording medium is measured by the sensors. Any difference in the arrival time of the paper edge is indicative of the amount in which the paper is skewed.

A concern of the solution proposed in JP 11301883 is that the sensor system can only detect whether or not the recording medium is fed to the printer in a skewed orientation. The sensor system cannot detect an error in the stepwise advancement or transport, i.e. movement between the recording medium and the print head of the printer, of the recording medium during the printing process. This makes the system of JP 11301883 unsuitable for printing relatively long pieces of recording medium.

### SUMMARY OF THE INVENTION

It would therefore be desirable to provide a method of applying an ink image to a receiving medium using a swath printer and to provide a swath printer which can detect errors in the movement between the receiving medium and a print head of the printer, both with respect to an error in the stepwise movement and with respect to an error which leads to a skewed orientation of the receiving medium with respect to the print head of the printer. It would further be desirable to provide at least a good alternative to the available swath printers and to the available method of applying an ink image to a receiving medium using a swath printer.

To better address one or more of these concerns, a first aspect of the present invention is directed to a method of applying an ink image to a receiving medium using a swath printer, the method comprising the steps of: a) moving a print head along a scan direction to print a swath; b) moving the receiving medium and the print head with respect to each other in a transport direction that is substantially orthogonal to the scan direction; c) detecting a position of a first reference pattern in a first area of the receiving medium; d) detecting a position of a second reference pattern in a second area of the receiving medium; e) determining a relative position between the receiving medium and the print head in the transport direction using the detected first and second positions; and f) moving the print head along the scan direction to print a further swath taking into account the determined relative position between the receiving medium and the print head in the transport direction.

By detecting the position of a first reference pattern and a second reference pattern on two distinct areas of the receiving medium, it has become possible to determine or calculate the position of the receiving medium at the position of both reference patterns and consequently one can determine an overall relative position between the receiving medium and the print head. In particular, it is possible to determine whether or not the receiving medium and the print head are in a skewed orientation with respect to each other, as two distinct positions of two reference patterns have been detected.

In an embodiment, step e) is effected by determining deviations in the detected positions of the first and second reference patterns from a desired position thereof. This increases the accuracy of the method.

In an embodiment, the print head is moved along the scan direction to print the further swath while applying a correction to correct for the detected deviations. In this manner, detected errors in the positioning between the receiving medium and the print head can be corrected directly after their detection and can it be ensured that subsequent swaths will connect correctly to previous swaths, so as to form a continuous image without printing errors, or at least without printing errors that are detectable by the human eye.

In an embodiment, step f) further comprises moving the receiving medium and the print head with respect to each other in a direction that is substantially orthogonal to the scan direction during printing of the further swath, so that errors in the movement of the receiving medium and the print head with respect to each other in the transport direction can be corrected.

In an embodiment, step f) further comprises moving the receiving medium and the print head with respect to each other in a direction that is angled with respect to the transport direction during printing of the further swath, so that errors in the movement of the receiving medium and the print head with respect to each other resulting in a skewed orientation can be corrected. Such correction may comprise rotating the receiving medium around a central axis and/or rotating the print head around a central axis, both in a plane that is substantially parallel to the plane wherein the receiving medium is located.

In an embodiment, the print head comprises a plurality of ejectors arranged to eject droplets of ink on the receiving medium, and step f) further comprises adjusting a volume of the droplets of ink during printing of the further swath.

In an embodiment, step f) further comprises adjusting the volume of the droplets of ink for those ejectors that print a border of an input bitmap adjoining an input bitmap printed in a previous swath, so that a proper connection between the subsequent print swaths can be made and an ink image without errors can be printed. In particular, when the detected error would result in a white line in the image, the volume of the droplets can be increased. In case the detected error would lead to a dark line to be printed, the volume of the droplets may be decreased. Adjusting the volume of the ejected droplets may also include disabling one or more ejectors.

In an embodiment, step f) further comprises adjusting the ink image to be printed for the detected deviations.

In an embodiment, the method further comprises shifting a remaining part of the input bitmap to be printed by an amount substantially equal to the detected deviations, so that a correct image with the correct dimensions will be printed.

In an embodiment, the reference patterns are provided in an area of the receiving medium that forms a margin in a transport direction thereof. By providing reference patterns in a marginal area of the receiving medium, the relative position of the receiving medium and the carriage with respect to each other can be determined during use of the printer, i.e. after printing each subsequent swath. This allows for a dynamic determination of the relative position and consequently allows for a dynamic error correction. It is noted here that such patterns could be patterns that are, for example, printed by the printer itself, patterns that are pre-printed on the receiving medium and also patterns that are present in the fabric of the receiving medium.

In another aspect of the present invention, a swath printer comprises: a print head, the print head being moveable along a scan direction for applying an ink image to the receiving medium; a transport mechanism configured to move the receiving medium and the print head with respect to each other in a transport direction that is substantially orthogonal to the scan direction; a first sensor arranged to detect a position of a first reference pattern present on the receiving medium in a first area thereof; a second sensor arranged to detect a position of a second reference pattern present on the receiving medium in a second area thereof; and a controller arranged to control the printer on the basis of the detected positions of said reference patterns during use of the printer.

Such a swath printer exhibits the same advantages as the method referred to above and is consequently able to determine or calculate the position of the receiving medium at the position of both reference patterns and consequently to determine an overall relative position between the receiving medium and the print head. In particular, it is able to determine whether or not the receiving medium and the print head are in a skewed orientation with respect to each other, as two distinct positions of two reference patterns can be detected.

Furthermore, in an embodiment, the reference parameters may be provided in a marginal area or margin of the receiving medium. Therefore, the relative position of the receiving medium and the print head with respect to each other can be determined during use of the printer, i.e. after printing each subsequent swath. This allows for a dynamic determination of the relative position and consequently allows for a dynamic error correction and will provide improved printing performance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will now be explained further with reference to the accompanying drawings, wherein:

FIG. 1 depicts a schematic setup of a swath printer;

FIG. 2 depicts a simplified block diagram of the operation of the swath printer;

FIGS. 3A and 3B depict an image of dots printed using a known printing method;

FIGS. 4A-4C depict an image of dots printed using the printing method according to an embodiment of the present invention, and

FIGS. 5A and 5B depict an alternate printer with a skewed orientation of the receiving medium and the carriage holding the print head.

### DETAILED DESCRIPTION OF THE INVENTION

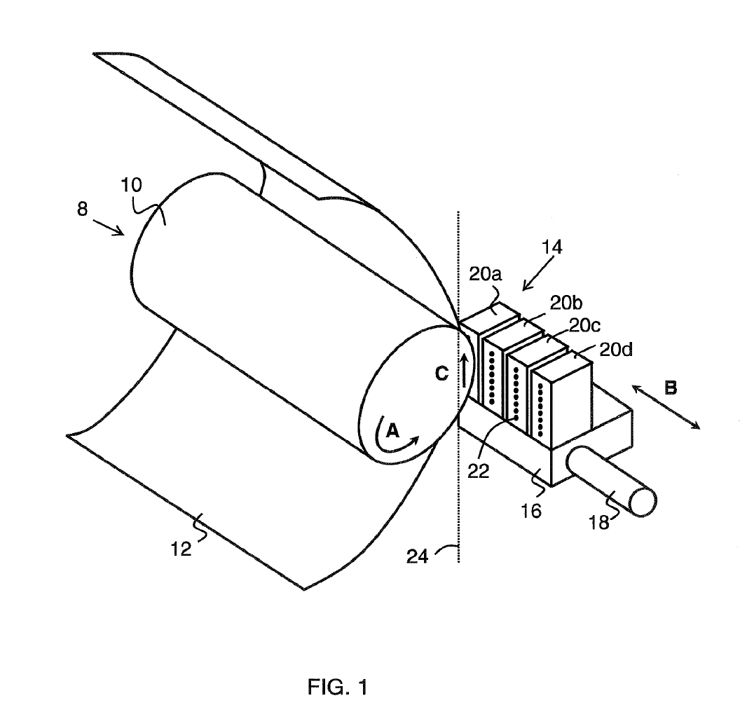

FIG. 1 schematically depicts a typical setup of a swath type printer, such as an ink jet printer, comprising a multi-nozzle print head 14 that is mounted on a carriage 16. The carriage 16 is guided on guide rails 18, on which the carriage 16 can travel back and forth across a receiving medium 12, such as a sheet of paper, in a direction indicated with a double arrow B. By moving the carriage 16 that carries the print head 14 along the guide rails 18, an image swath (i.e. an image strip with several dot lines) can be printed on the receiving medium 12 with each pass of the print head 14. The direction of movement B is also called the scan direction or scan axis of the printer.

In the example of FIG. 1, the receiving medium 12 is transported by means of a rotary unit 8 having a feed roller 10. However, it is also possible that the receiving medium 12 is, for example, placed on a substantially flat surface over which it is transported with respect to the print head 14, or over which the print head 14 carried by the carriage 16 is transported. Such configurations can, for example, be used when sheets of non-flexible material are used, or when non-standard shapes and/or sizes of sheets need to be printed. Hence, it is possible to move the receiving medium 12 and the print head 14 with respect to each other in a number of alternative ways.

To continue with the example of FIG. 1, which is not intended to be limitative in any way, the rotary unit 8 and the feed roller 10 operate as a transport mechanism that is configured to move the receiving medium 12 and the print head 14 with respect to each other in a transport direction C by rotating the feed roller 10 in a direction A. When the feed roller 10 is rotated in the direction of the arrow A, a sheet of the recording medium 12 is advanced in the direction represented by the arrow C along a path 24. The direction C is the transport or sub-scanning direction of the printer and the direction B is the main scanning direction, i.e. the direction in which the print head 14 moves back and forth along the scan direction. A camera (not shown) may be mounted on the carriage 16 for imaging an area on the image receiving medium 12, which area extends in the sub-scanning direction C.

A controller (not shown) can control a drive motor connected to the transport mechanism so as to advance the receiving medium or sheet 12 by a desired amount, once the carriage 16 carrying the print head 14 has performed a pass across the sheet 12. After an image swath has been printed, the sheet 12 is thus advanced by a length equal to a step value, so that the next image swath can be printed and connected to the previous image swath. During each printer swath, an input bitmap is printed. The print head 14 may comprise four nozzle heads 20a-20d as shown in the example, whereby for example one nozzle head is provided for each one of the basic colors, yellow, magenta, cyan and black. Ink for printing the image may be supplied from an ink container in a manner known per se to one having ordinary skill in the art. On the part of the print head 14 that faces the sheet 12, each nozzle head 20a-20d comprises one or more linear arrays of ink ejectors or nozzles 22, which are arranged to eject droplets of ink on the sheet 12 in response to a driving signal from the controller (not shown).

The nozzle heads 20a-20d are energized in accordance with digital image data of an image to be printed onto the sheet 12. Driving signals in accordance with the image data are provided to the print head 14 through a connector (not shown) mounted on the carriage 16 or through any other suitable way. Each ejector 22 can be energized separately so as to eject an ink droplet, which will form an ink dot at a corresponding pixel position on the sheet 12. Thus, when the print head 14 performs a single pass over the sheet or receiving medium 12, each ejector 22 can be energized to draw a single dot line of the intended image. As a result, during each pass of the carriage 16, the print head 14 will print a swath of the image based on an input bitmap. Although only eight nozzles 22 are shown per nozzle head 20a-20d in FIG. 1, in practice, a different number of nozzles may be considered.

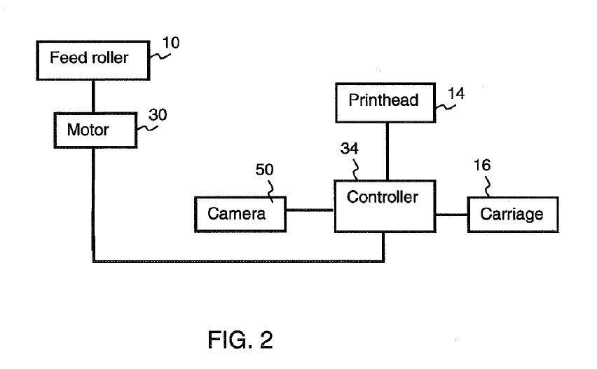

FIG. 2 shows a simplified component diagram of a printer according to the present invention. The printer may comprise the print head 14 with the nozzle heads 20a-20d, the carriage 16, a camera 50 which may be mounted on the carriage 16, and a controller 34 which is arranged to control the printer and its components such as the motor 30 so as to rotate the feed roller 10 for moving the receiving medium or sheets by a required length. As mentioned above, the printer may also be arranged such that the carriage that carries the print head 14 is moved with respect to the receiving medium. Furthermore, different solutions are possible for transporting the receiving medium and the print head with respect to each other.

The control unit 34 is adapted to control the various components of the printer. The control unit 34 may comprise a central processing unit (CPU), a storage device, such as an electronic memory, and an image processing unit, whereby all of said components can be functionally connected to each other, for example through a bus or any other suitable way. The controller executes various tasks which are required to control the respective components of the printer.

The control unit 34 is arranged to receive a document or an image to be printed in digital form, for example a page description language (PDL) file which describes the layout and graphical objects of the document to be printed. Such a PDL file can be submitted, together with print settings, to the image processing unit which has functions for half toning the data of the digital document to be printed. Once half toning of the data has been executed, image data in the form of an array of pixels (i.e. a bitmap) to be used by the print head is available. The array of pixels (input bitmap) constitutes information usable to control the ejectors or nozzles 22 of the nozzle heads 20a, 20b, 20c and 20d of the print head 14, so that the nozzles can eject ink dots onto the receiving medium at corresponding pixel positions in the bitmap. During each pass of the carriage 16 which carries the print head 14, the nozzles of the print head are activated according to a swath print mask, which allocates an ink ejecting element to pixel positions in the bitmap in such a way that the pixels are rendered by ink dots, where required, at the corresponding pixel positions.

The control unit 34 may also directly or indirectly control the motor 30 so as to move the receiving medium 12 by a required length in the transport direction, once the carriage 16 with the print head 14 has performed a pass across the receiving medium. The controller may also control the movement of the carriage 16.

The controller may also be arranged to receive signals indicative of an image sensed by the camera 50. In an embodiment, the signals are used to execute the method for printing an array of dots representing image data.

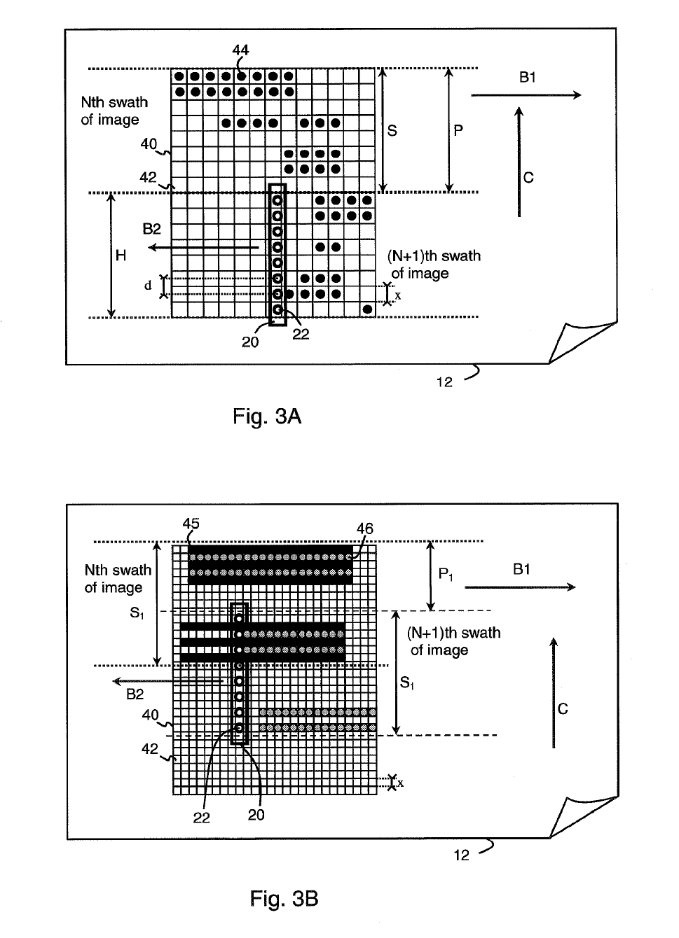

For a better understanding of how a swath or inkjet type printer works, two basic examples are given referring to FIGS. 3A and 3B. FIGS. 3A and 3B schematically show ink dots as printed by a simplified print head on a receiving medium or sheet 12, using a known method for printing an array of dots.

FIG. 3A depicts an example of a so-called single pass bi-directional printing method. For clarity purposes, throughout the description, printing ink dots is explained using a simplified print head 20 representing any of the nozzle heads 20a, 20b, 20c or 20d or any combination thereof or the whole print head 14. The print head 20 comprises a limited number of ejectors or nozzles 22 arranged according to a single linear array. An imaginary grid 40 comprising a plurality of cells 42 represents the resolution of the array of pixels to be rendered, for example 150 pixels per inch. Since ink dots are printed at corresponding pixel positions, the resolution of the printed image in the example of FIG. 3A is 150 dpi (dots per inch). The result obtained after printing an Nth swath of the image is visible in the upper part of FIG. 3A, in which upper part a number of ink dots 44 are located on the recording medium 12 at corresponding pixel positions represented by the cells 42. The Nth swath of the image is the result obtained after one pass of the carriage along the scan direction B1. Since printing is bi-directional, the scan direction has actually two sub-directions, B1 (from left to right) and B2 (from right to left) as indicated in FIG. 3A. The Nth swath of the image has a height S. Once the Nth swath of the image is printed, the recording medium is advanced in the transport direction C by an amount having a step value P. In the single pass print mode, the step value P is ideally equal to the height S of each image swath. In this ideal case, the whole image is rendered by a plurality of image swaths perfectly joined with each other so as to form a single image.

After the sheet 12 and the print head 14 have been moved with respect to each other by an amount having a step value P, the (N+1)th swath of the image can be rendered during one pass of the print head 20 in the sub-direction B2. In FIG. 3A (lower part), the situation is depicted wherein the print head 20 is actually printing ink dots while it is moved, together with the carriage. The nozzles 22 of the print head 20 are energized in accordance with image signals controlled by the controller, so as to print ink dots 44 at cell positions 42 corresponding to the pixel positions in the bitmap. In the example, the print head 20 comprises eight nozzles 22 spaced from each other by a nozzle pitch d. The height of the print head 20 is indicated with reference sign H. The height of the print head 20 is by definition equal to the number of nozzles multiplied by the pitch d. For example, the height H of the print head may be equal to the swath height S. Alternatively, if the print head is, for example, provided with spare nozzles, the height H may of course be larger than the swath height S. The spare nozzles are normally not used, however, they may be useful in the case of nozzle failures.

FIG. 3B represents a situation in which printing is performed according to the so-called bi-pass bi-directional method, using the same print head 20 as depicted in FIG. 3A, having the same nozzle pitch d. The imaginary grid 40 comprising a plurality of cells 42 represents the resolution of an array of pixels to be rendered, now for example 300 pixels per inch. Since ink dots are printed at corresponding pixel positions, the final resolution of the printed image is 300 dpi (dots per inch). During an Nth swath of the image, ink dots 45 are printed on the recording medium 12 with a print resolution (150 dpi), which is half of the final resolution (300 dpi). The Nth swath of the image is the result obtained after one pass of the carriage in the direction B1. During an (N+1)th swath of the image, ink dots 46 are printed in one pass of the carriage in the direction B2. Ink dots 46 are also printed on the receiving medium 12 with a print resolution (150 dpi) which is half of the final resolution. As can be seen in FIG. 3B, the Nth swath of the image and the (N+1)th swath of the image are interlaced so as to form a part of the printed image with the final required resolution (300 dpi). The print head 20 can produce a print resolution of 150 dpi in one swath. After the Nth swath of the image, the receiving medium 12 is advanced by a step having a length P1, which is equal to half the swath height S1 plus the side length x of a cell 42.

The tolerances allowed for or the deviations that are still acceptable for the length of step P and P1 are smaller than the printing resolution of the printer. This is mainly caused by the ability of the human eye to detect printing errors such as dark lines where the step length is too short and subsequent swaths overlap, or white lines when the step is too large and the images printed in subsequent swaths do not connect properly. Also a combination of these printing errors may arise when the receiving medium and the print head are moved with respect to each other with a so-called left-right error, i.e. a difference in (paper-)step between both longitudinal sides of the receiving medium as seen in transport direction.

Now that the general functioning of a swath printer has been described, a more detailed description of solutions proposed according to the present invention for alleviating the problems associated with paper step or transport step errors will be provided.

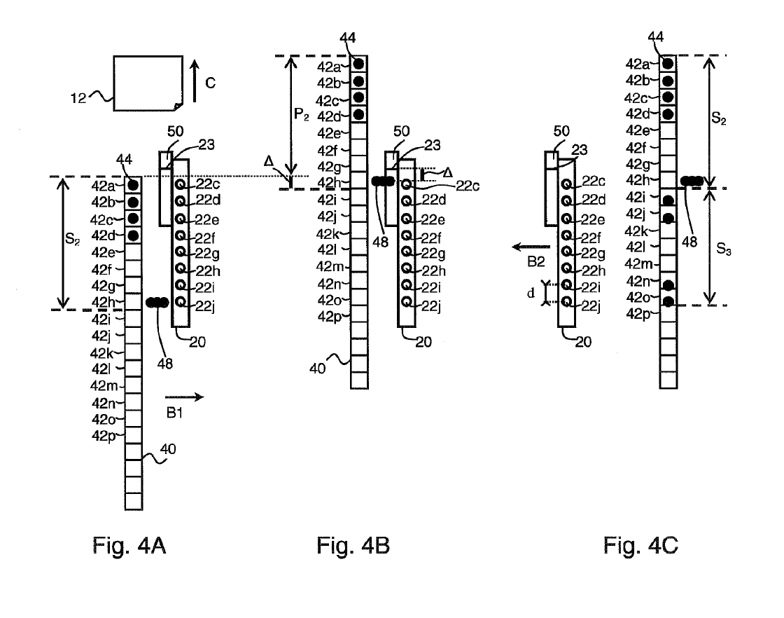

As mentioned above, a swath printer such as an inkjet type printer requires that the receiving medium and the carriage that carries the print head to be moved with respect to each other in order for several swaths to be printed, whereby the printed swaths form a single image. These swaths must be properly aligned with respect to each other in order to print a defect free image. A possible way of achieving such alignment is described with reference to FIGS. 4A to 4C.

FIGS. 4A to 4C schematically show a single column of the imaginary grid 40 together with the relative position of the print head 20. In FIG. 4A, cells 42a, 42b, . . . , 42o and 42p are labelled and correspond to pixel positions in the array of pixels (bitmap) to be printed by the print head 20. The print head 20 is shown to comprise eight nozzles for ejecting ink droplets, which form dots 44 on the receiving medium or sheet 12. The nozzles are labelled: 22c, 22d, 22e, 22f, 22g, 22h, 22i, and 22j. In the example of FIG. 4A, the sheet 12 is stepwise transported to allow for subsequent print swaths to be printed. However, it is to be understood that what is described will also apply to a stationary sheet or receiving medium and a carriage holding a print head that is stepwise transported or moved with respect to the sheet.

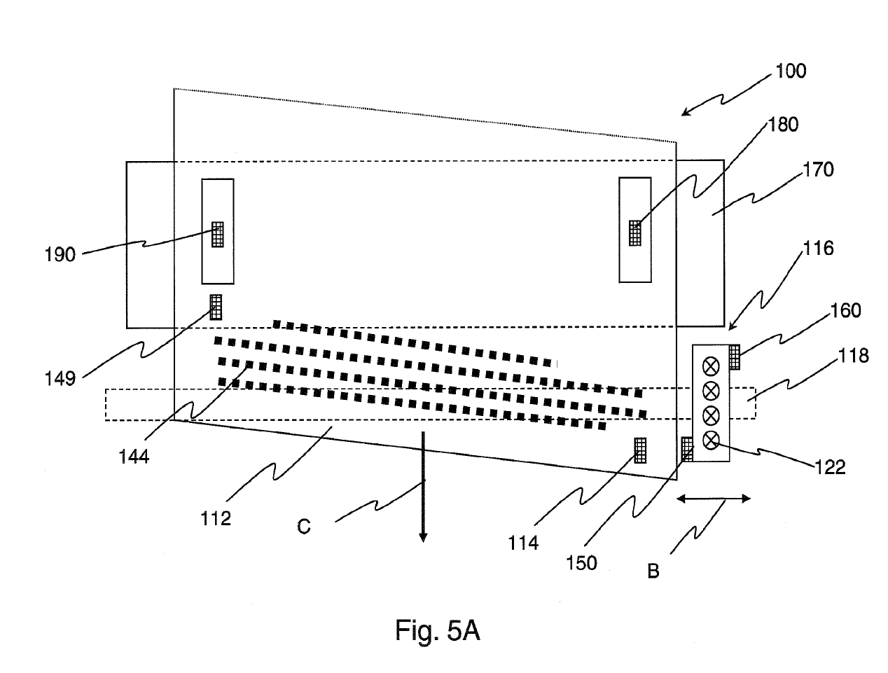

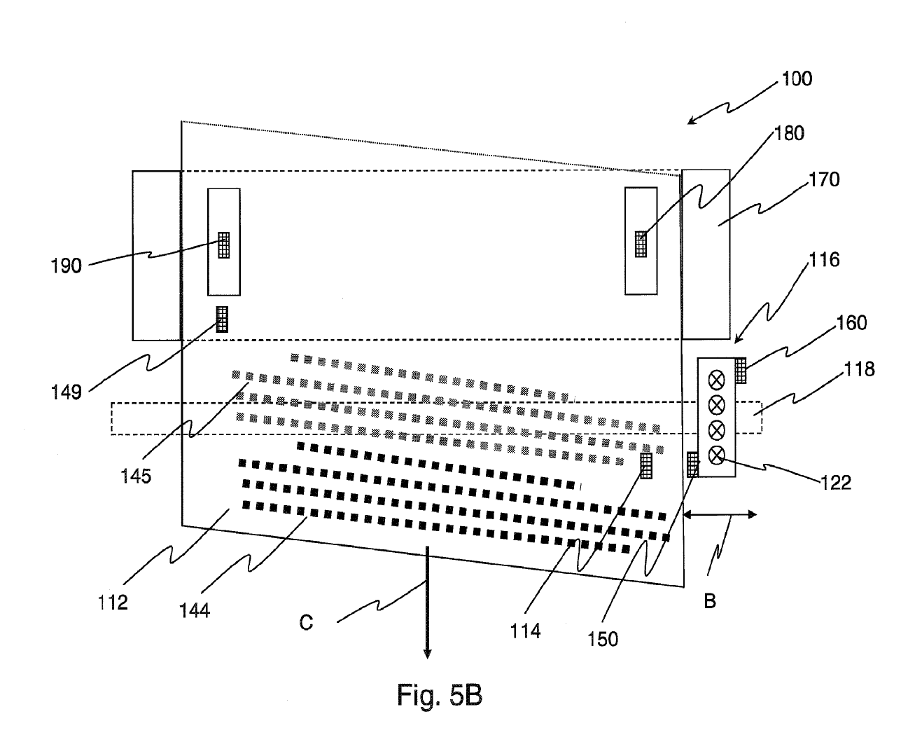

A sensor or camera 50 is mounted on the carriage of the print head 20. The sensor 50, for example a CCD camera is adapted for imaging an area on the receiving medium 12 and to transmit electric signals to the controller 34 in accordance with the imaged area. In the example of FIGS. 4A-4C, the lens of the camera comprises a marker 23, for example a stroke, which can be used as a reference or reference pattern for the camera and which overlaps the imaged area on the receiving medium. The image taken by the camera comprises an image of the area, and superposed thereon, an image of the marker or reference pattern 23. By comparison of the reference pattern or patterns with the observations of the camera, a position of the print head with respect to the reference pattern can be determined. However, such a marker is preferably provided on the surface of the receiving medium 12 itself, whereby such a marker or reference pattern can be either printed on the receiving medium 12 by the printer, be pre-printed thereon or may be formed by the fabric of the receiving medium itself, for example may be formed by the fibers of the receiving medium such as paper fiber patterns, in case the receiving medium is paper. This will be explained in more detail, for example, with reference to FIGS. 5A and 5B. The electric signals transmitted to the controller represent an image of the reference pattern or marker 23 together with the imaged area on the recording medium, and enable the control unit to determine precisely the position of the print head with respect to a reference pattern on the recording medium.

In the example of FIG. 4A, a reference mark or reference pattern 48 is printed by the nozzle 22j of the print head 20 in a marginal area of the printed image, i.e. on the right side of the image. Such a marginal area is usually located next to one of the longitudinal sides of the sheet 12, i.e. a side which extends in the transport direction. The reference mark 48 may be a yellow pattern that is not visible to the human eye. Alternatively, the reference mark 48 may also be formed by the structure or fabric of the receiving material itself. However, the present invention will be further explained using a printed reference mark or reference pattern, which is the preferred way of providing a reference pattern, because of its ease and simplicity.

FIG. 4A represents the situation occurring immediately after the carriage has performed one pass in the direction B1. The height of the resulting image swath is S2. During said pass, the nozzles have been activated according to a first swath print mask, which allocates an ejector (nozzle) to a pixel position in such a way that said pixel is rendered by an ink dot. According to said first swath print mask, the nozzles 22c, 22d, 22e, 22f, 22g, 22h, 22i and 22j are allocated to the pixel positions 42a, 42b, 42c, 42d, 42e, 42f, 42g and 42h, respectively.

After the reference pattern 48 has been printed, for example by the nozzle 22j, the controller 34 controls the motor 30 so as to rotate the feed roller 10 and to advance the recording medium 12 by a length of the sheet advance step. Ideally, the length of the advance step should be equal to S2, the height of the preceding image swath. If the length of the advance step was S2, the second print mask for the second image swath to be printed would attribute the nozzles 22c, 22d, 22e, 22f, 22g, 22h, 22i and 22j, respectively to the pixel positions 42i, 42j, 42k, 421, 42m, 42n, 42o and 42p.

However, due to a transport error, an error in the length of the advance step occurs in the transport direction. This is shown in FIG. 4B, in which it is seen that the actual length of the advance step P2 is smaller than the desired length thereof. The deviation of the actual step value P2 from the desired value is equal to Δ. After the medium has been advanced by the advance step P2, the sensor 50 optically senses the imaging area represented in FIG. 4B by the area of the rectangle 50. The image taken by the sensor 50 comprises at least a part of the printed reference pattern 48 and the reference marker 23 in case that the lens is provided with the reference marker 23. This image is sent to the controller 34 for analysis. Thereon, the controller 34 determines the deviation Δ, based on the position of the reference pattern 48 with respect to the position the reference marker 23 in the taken image and thus with respect to the print head 20 (carriage). Ideally, if the length of the advance step P2 is equal to the desired value S2, the reference mark 48 should be perfectly aligned with the pattern 23. The distance between the pattern 48 and the marker 23 on the taken image enables the controller 34 to determine the value of the deviation Δ. In the example illustrated in FIG. 4B, the value of the deviation Δ is equal to about three quarters of the nozzle pitch d (Δ=0.75 d). The controller determines whether the deviation Δ is larger than half the nozzle pitch d. Since the value of the deviation Δ is larger than half the nozzle pitch d, the image processing unit of the controller 34 reshuffles the swath print mask for the next swath (i.e. the second swath) of the image to be printed. This is required, because without reshuffling, the nozzle 22c would be allocated to the pixel line to which the pixel position 42i belongs. However, the nozzle 22c is not aligned with the cell 42i in the main-scan direction B2. This would lead to a visible error in the printed image. The overlap between the first and the second swath of image would produce a dark line on the printed image.

Reshuffling the next swath print mask (i.e. putting the mask into a new arrangement) is performed by the image processing unit of the controller 34 such that the first ink dot line of the second swath is printed by the nozzle that is the closest to a position on the sheet 12 corresponding to the next pixel line to be rendered, based on the deviation Δ. FIG. 4C illustrates the result of the reshuffling. Among all nozzles of the print head 20, nozzle 22d is the closest to cell 42i, which is the corresponding position of the first pixel of the next pixel line to be printed. After reshuffling, the nozzles 22d, 22e, 22f, 22g, 22h, 22i and 22j are allocated to the pixel positions 42i, 42j, 42k, 421, 42m, 42n and 42o, respectively. As can be seen in FIG. 4B, the nozzle 22c is disabled while printing the second image swath. Consequently, less nozzles (seven) are used than are available (eight) on the print head 20, and the swath height S3 of the second swath is smaller than S2. The second swath has a height S3, which is smaller than the maximum printable swath S2. If the steps described above are repeated, and if a comparable deviation Δ is determined after each image swath, additional swaths are required to print the whole image. Hence, the ink image to be printed can be adjusted to compensate for the detected errors.

It is noted here again, that the above is of course equally applicable to the preferred embodiment wherein a reference pattern that is present on the surface of the receiving medium itself is used to determine deviations between the actual length of the advance step and the desired length thereof.

In a further preferred embodiment, the print head 20 may be provided with additional nozzles that are disabled when there is no deviation between the desired transport step and the actual transport step. However, in case that the actual transport step is larger than the desired step, in a way that is similar as described above, these nozzles can be activated to compensate or correct for the detected error.

Another way of applying a correction for the detected errors or deviations can be effected by controlling the volume of the ink droplets that are ejected by the ejectors. The droplets of ink are ejected in response to a driving signal that originates from the controller, and adjusting of said volume is effected by changing a voltage level and/or a pulse width of said driving signal.

Yet another alternative way of correcting errors is to eject droplets of ink on the receiving medium in response to a driving signal, whereby the timing of providing the driving signal to said ejectors is adjusted so as to vary the moment at which the ink droplets are ejected towards the receiving medium. As the correction is preferably done while printing, timing of the moment at which the droplets are ejected can correct detected errors. In particular, when the detected error would result in a white line in the image, the moment of ejection of the droplets can be brought forward. In case the detected error would lead to a dark line to be printed, the moment of ejection of the droplets may put backward.

Yet another alternative way of correcting errors comprises shifting a remaining part of the input bitmap to be printed in a swath by an amount substantially equal to the detected errors or deviations from the ideal or desired position.

With the above-described method using a single sensor that can detect the position of a reference pattern located on the receiving medium, an error in the stepwise displacement of the receiving medium and the carriage holding the print head can be detected. When this solution is extended, i.e. the sensor 50 is also used to detect a position of a second reference pattern located in a second marginal area of the receiving medium in a way that is similar to the way described above with reference to FIGS. 4A-4C, two separate measurements result for the deviation in the transport step for the two marginal areas. In particular, when the reference patterns are located in opposite marginal areas it is possible to detect any so-called left-right errors that introduce a skewed orientation of the receiving medium with respect to the carriage holding the print head. This will be explained in more detail with reference to FIGS. 5A and 5B.

FIG. 5A shows a schematic plan view of a swath printer 100 for printing an ink image on a receiving medium or sheet 112. The printer 100 comprises a carriage 116 on which a multi-nozzle print head 114 is mounted. In the example of FIG. 5A, the print head 114 is shown to comprise a total of four nozzles 122, but it is noted that the number of nozzles may of course be different. Here the number of four nozzles is mainly shown for illustrative simplicity of the drawing. The carriage 116 is guided over a guide rail 118 in a driven manner by means of a non-shown motor. The carriage 116 that is holding the print head 114 can be moved back and forth along the guide rail 118 in a direction B or scan-direction as is indicated by means of a double arrow in FIG. 5A. In the example of FIG. 5A, the sheet 112 can be moved with respect to the carriage 116 in a transport direction C by means of non-shown transport mechanism under control of a controller. It is noted however that it is also conceivable that the sheet 112 is stationary and that the carriage 116 is moved by the transport mechanism along the length of the sheet 112 so as to print the ink image.

In the example of FIG. 5A, the sheet 112 is located on a schematically depicted support surface 170 and is transported in the transport direction C in a stepwise manner so as to enable the printing of subsequent print swaths as explained above. As can be seen, the situation of FIG. 5A shows that a transport error has occurred that has led to the situation that the sheet 112 and the carriage 116 with the print head 114 are in a skewed orientation with respect to each other. This situation is also known as a left-right error, wherein the sheet 112 has moved during printing, such that the ink image 144 is no longer substantially orthogonal with the direction of transport C.

The printer 100 comprises a first sensor 150 and a second sensor 160 which are mounted on the carriage 116 on opposite sides thereof. As explained above with reference to FIGS. 4A to 4C, the sensors 150, 160 may be a camera such as a CCD camera that is arranged to detect a reference pattern. In the example of FIG. 5A, a first reference pattern 148 and a second reference pattern 149 are present in a first and second marginal area of the sheet 112, respectively. The first and second marginal areas are located along the longitudinal sides of the sheet 112, as can be gleaned from the Figure. The reference patterns 148, 149 are for example printed by the print head 114 as has been explained earlier in a previous print swath. By detecting the positions of both reference patterns using the sensors on the carriage 116, the relative position of both reference patterns 148, 149 with respect to the carriage can be determined. More in particular, deviations from the detected positions of said reference patterns compared to a desired position, i.e. the correct transport step, can be determined and it can be determined whether or not there is any skewed orientation between the carriage 116 and the sheet 112. It is noted that said comparison of the detected position with the desired position does not necessarily involve the provision of a reference marker on a lens of one of the sensors as described with reference to FIGS. 4A-4C. In fact, the comparison may also be done by comparing the “image” made or detected by the sensor of the reference pattern in an electronic memory where the desired “image,” or at least its electronic representation, is available. Here the term “image” may also include an electronic signature or optical signature that is indicative of the reference pattern. Such a signature is then compared with a desired signature. Deviations there from can then be calculated back into actual deviations from a desired position.

So, with the exemplified set-up, the relative position of the sheet 112 with respect to the carriage 116 can be determined after every print swath and corrective actions such as described above can be used to correct any errors detected.

As an alternative to providing the sensors 150, 160 on the carriage 116 it is also possible to provide sensors in the support surface 170. This example is also shown in FIG. 5A, where the alternate sensors are shown as reference numbers 180 and 190. In this example, the sensors 180, 190 will face a surface of the sheet 112 that faces away from the print head 114 and preferably the reference patterns to be detected are formed by the structure of the material of the sheet 112. In yet another alternative, the sensors 180, 190 are mounted in a frame (not-shown) that is located over the surface of the sheet 112 that faces the print head 114 such that the sensors 180, 190 are facing ‘downward’. Furthermore, it is also conceivable to use a combination of both sensor set-ups for improved accuracy of the printer 100.

In addition to the solutions described with reference to FIGS. 4A to 4C for correcting transport errors, a further solution is described with reference to FIG. 5B.

FIG. 5B shows the same set-up as FIG. 5A with the difference that the sheet 112 has been transported in the transport direction C so that another print swath could be printed. This subsequent swath or ink image is indicated with reference numeral 145. As can be seen, the subsequent swath 145 connects correctly to the previous swath 144 as it has the same angle with respect to the transport direction C as the previous swath. This has been achieved by moving the sheet 112 with respect to the carriage 116 during movement of the carriage 116 along the scan axis B. In this manner it is possible to provide an ink image that may have a skewed orientation on the sheet 112, but will be correctly printed without visible errors. The movement of the sheet 112 may be in the same or opposite direction as the transport direction C. It is of course also possible to move the carriage 116 along the transport direction C to achieve the same effect.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps).

The mere fact that certain measures are recited in mutually different dependent claims does not indicate that a combination of these measures cannot be used to advantage.

A single processor or other unit may fulfil the functions of several items recited in the claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of applying an ink image to a receiving medium using a swath printer, said method comprising the steps of:
a) moving a print head along a scan direction to print a swath;
b) moving the receiving medium and the print head with respect to each other in a transport direction that is substantially orthogonal to the scan direction;
c) detecting a position of a first reference pattern in a first area of the receiving medium;
d) detecting a position of a second reference pattern in a second area of the receiving medium;
e) determining a relative position between the receiving medium and the print head in the transport direction using the detected first and second positions; and
f) moving the print head along the scan direction to print a further swath taking into account the determined relative position between the receiving medium and the print head in the transport direction.

2. The method of claim 1, wherein step e) is effected by determining deviations in said detected positions of the first and second reference patterns from a desired position thereof.

3. The method of claim 2, wherein the print head is moved along the scan direction to print the further swath while applying a correction to correct for said detected deviations.

4. The method of claim 1, wherein step f) further comprises moving the receiving medium and the carriage with respect to each other in a direction that is substantially orthogonal to the scan direction during printing of the further swath.

5. The method of claim 1, wherein step f) further comprises moving the receiving medium and the print head with respect to each other in a direction that is angled with respect to the transport direction during printing of the further swath.

6. The method of claim 1, wherein step b) comprises a stepwise moving of the receiving medium and the print head with respect to each other.

7. The method of claim 1, wherein the print head comprises a plurality of ejectors arranged to eject droplets of ink on the receiving medium, and step f) further comprises adjusting a volume of the droplets of ink during printing of the further swath.

8. The method of claim 7, wherein step f) further comprises adjusting the volume of the droplets of ink for those ejectors that print a border of an input bitmap adjoining an input bitmap printed in a previous swath.

9. The method of claim 1, wherein step f) further comprises adjusting the ink image to be printed for the detected deviations.

10. The method of claim 9, further comprising shifting a remaining part of the input bitmap to be printed by an amount substantially equal to said detected deviations.

11. The method of claim 1, wherein said reference patterns are provided in an area of the receiving medium that forms a margin in a transport direction thereof.

12. A swath printer, comprising:
a print head, the print head being moveable along a scan direction for applying an ink image to the receiving medium;
a transport mechanism configured to move the receiving medium and the print head with respect to each other in a transport direction that is substantially orthogonal to the scan direction;
a first sensor arranged to detect a position of a first reference pattern present on the receiving medium in a first area thereof;
a second sensor arranged to detect a position of a second reference pattern present on the receiving medium in a second area thereof; and
a controller arranged to control the printer on the basis of the detected positions of said reference patterns during use of the printer.

13. The printer of claim 12, wherein the controller is further arranged to determine deviations in said detected positions from a desired position thereof.

14. The printer of claim 12, wherein the sensors are provided in a support surface of the printer arranged to support the receiving medium, and wherein the reference patterns are provided at a surface of the receiving medium that faces away from the print head.

15. The printer of claim 12, wherein the sensors are provided over a receiving surface of the receiving medium, the receiving surface facing the print head.

16. The printer of claim 12, wherein the sensors comprise a CCD camera.

17. The printer of claim 12, wherein the controller is further arranged to move the receiving medium and the print head with respect to each other in a direction that is substantially orthogonal to the scan direction during printing of the further swath.

18. The printer of claim 12, wherein the controller is further arranged to move the receiving medium and the print head with respect to each other in a direction that is angled with respect to the transport direction during printing of the further swath.

19. The printer of claim 13, wherein the controller is further arranged to adjust the ink image to be printed for the detected deviations.
